(19) United States
(12) Patent Application Publication
(10) Pub. No.: US 2020/0108687 A1
(43) Pub. Date: Apr. 9, 2020

(54) AUTOMATIC TEMPERATURE CONTROL ACTUATOR

(71) Applicant: Red Dot Corporation, Seattle, WA (US)

(72) Inventor: Peder L. Hamberg, Maple Valley, WA (US)

(21) Appl. No.: 16/151,229

(22) Filed: Oct. 3, 2018

(51) Int. Cl. B60H 1/00

(52) U.S. Cl. CPC B60H 1/0065; B60H 1/00035; B60H 1/00428; B60H 1/00585; B60H 2001/2246; B60H 1/00878; B60H 1/00964; B60H 1/00985; B60H 2001/0015; B60H 1/00792

(57) ABSTRACT

A rotary actuator including a rotatable shaft, at least one processor, and memory storing instructions executable by the processor(s). The instructions, when executed by the processor(s), cause the processor(s) to determine a temperature difference and rotate the rotatable shaft based at least in part on the temperature difference. The temperature difference is between a desired temperature setpoint value and a measured temperature value. The rotation of the rotatable shaft increases or decreases heat contributed by a heat-supplying device when the rotatable shaft is connected to the heat-supplying device.

### BACKGROUND OF THE INVENTION

### Field of the Invention

The present invention is directed generally to actuators used to control air temperature inside a passenger compartment of a vehicle.

### Description of the Related Art

FIG. 1 is a circuit diagram of a prior art circuit 100 used to control air temperature inside a passenger compartment of a vehicle (e.g., a car, a truck, and the like). The circuit 100 includes a control panel portion 110, a rotary actuator 112, a control module or Electronic Control Unit (“ECU”) 114, a fan 116, and a clutch 118. The control panel portion 110 includes a temperature control 120 configured to send a control signal encoding a temperature setpoint value to the ECU 114. In the example illustrated, the temperature control 120 includes a potentiometer 122 configured to change a property (e.g., voltage) of the control signal. The control signal is transmitted (e.g., via a conductor 124) to the ECU 114.

The ECU 114 includes memory and a processor (e.g., a microcontroller). The memory stores embedded software that is executable by the processor. The software causes the ECU 114 to obtain the temperature setpoint value from the control signal and determine a rotational angle command based on the temperature setpoint value. The software causes the ECU 114 to encode the rotational angle command in a command signal and send the command signal to the rotary actuator 112 (e.g., via conductors 130 and 132). The rotational angle command directs the rotary actuator 112 to turn a shaft (not shown) to a desired position that opens or closes a heater water valve (not shown) or positions one or more air temperature blend doors (not shown). Then, the rotary actuator 112 turns the shaft (not shown) to the desired position based on the rotational angle command.

### BRIEF DESCRIPTION OF THE SEVERAL VIEWS OF THE DRAWING(S)

FIG. 1 is a circuit diagram of a prior art circuit used to control air temperature inside a passenger compartment of a vehicle.

FIG. 2 is a circuit diagram of a circuit that includes an Automatic Temperature Control (“ATC”) system.

FIG. 3 is a block diagram illustrating exemplary components of a rotary actuator of the ATC system of FIG. 2.

Like reference numerals have been used in the figures to identify like components.

### DETAILED DESCRIPTION OF THE INVENTION

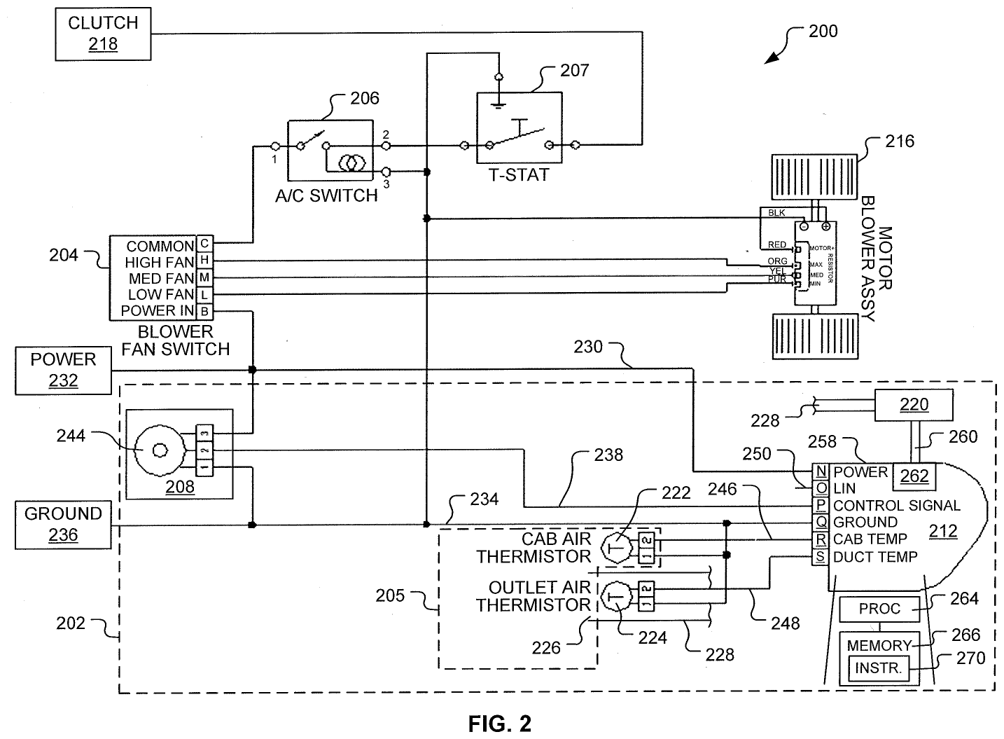

FIG. 2 is a circuit diagram of a circuit 200 that includes an Automatic Temperature Control (“ATC”) system 202, a blower fan switch 204, an air conditioner (“A/C”) switch 206, a thermostat switch 207, a blower assembly 216, and a compressor clutch 218. The ATC system 202 illustrated provides ATC in an occupied or passenger compartment 205 of a vehicle (e.g., a car, a truck, and the like). ATC refers to maintaining the air temperature (and optionally the humidity) inside the passenger compartment 205 at a desired level, regardless of weather conditions outside the vehicle.

In the circuit 200, the blower fan switch 204, the A/C switch 206, and the thermostat switch 207 are not part of the ATC system 202 and may be controlled manually. The A/C switch 206, the thermostat switch 207, and the compressor clutch 218 may be components of an air conditioning subsystem configured to provide cooled air to the passenger compartment 205.

The blower fan switch 204 controls the blower assembly 216. The blower assembly 216 is configured to move air through at least one duct 228. The duct(s) 228 has/have one or more outlets 226 in fluid communication with the passenger compartment 205. The air condition subsystem may supply the cooled air to one or more of the duct(s) 228. In such embodiments, the cooled air travels through the duct(s) 228 and enters the passenger compartment 205 through the outlet(s) 226.

The ATC system 202 includes a rotary actuator 212, an input 208, a heat-supplying device 220, a first (“cab air”) sensor 222, and a second (“outlet air”) sensor 224. In the embodiment illustrated, the first and second sensors 222 and 224 have each been implemented as a thermistor. However, this is not a requirement.

The heat-supplying device 220 is connected to the duct(s) 228 and supplies heat thereto. Heat supplied by the heat-supplying device 220 travels through the duct(s) 228, exits therefrom through the outlet(s) 226, and enters the passenger compartment 205. The heat may be supplied to the duct(s) 228 as heated air that the blower assembly 216 helps move through the duct(s) 228. The blower fan switch 204, which controls the blower assembly 216, may determine a speed at which the heated air travels through the duct(s) 228.

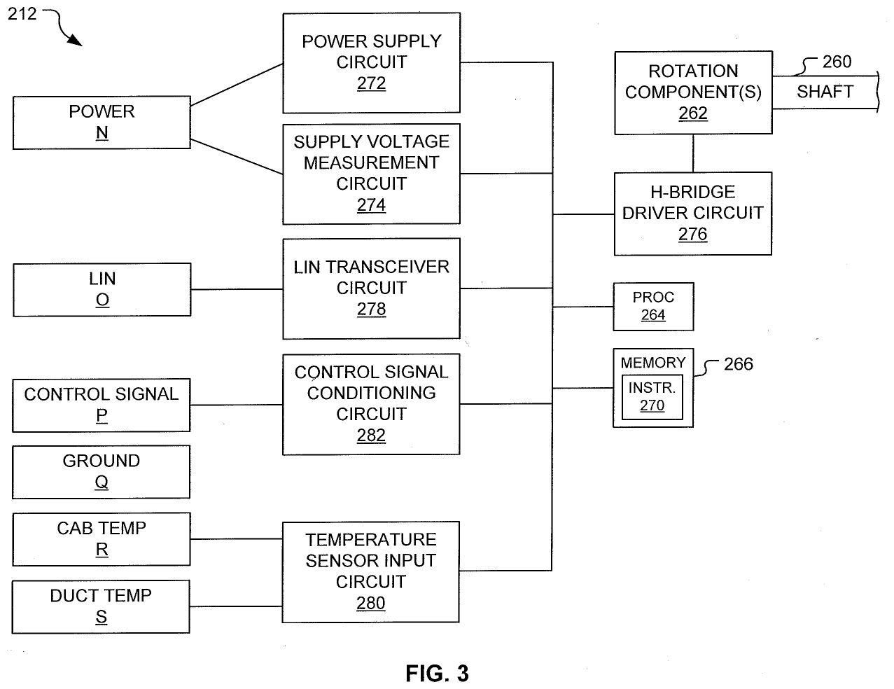

The actuator 212 has an outer housing 258, inputs “N,” “P,” “Q,” “R,” and “S,” an output “O,” a shaft 260, one of more rotation components 262, a processor 264, and memory 266. Referring to FIG. 3, the actuator 212 may also include one or more of the following additional components: a power supply circuit 272, a supply voltage measurement circuit 274, an H-bridge driver circuit 276, a LIN transceiver circuit 278, a temperature sensor input circuit 280, and a control signal conditioning circuit 282. Each of these additional components may be connected to the processor 264 and/or the memory 266. Because these additional components are well known and understood, they have not been illustrated and will not be described below.

Referring to FIG. 2, the inputs “N,” “P,” “Q,” “R,” and “S” and the output “O” are positioned along the outer housing 258. The shaft 260 has a proximal end opposite a distal end. The proximal end is connected to the rotation component(s) 262 inside the outer housing 258. The distal end extends outwardly away from the outer housing 258 and is connected to the heat-supplying device 220. The processor 264 and the memory 266 both reside inside the outer housing 258.

The input “N” (labeled “POWER” in FIG. 2) is connected (e.g., by a conductor 230) to a power source 232 and the input “Q” (labeled “GROUND” in FIG. 2) is connected (e.g., by a conductor 234) to ground 236. The power source 232 provides power to the actuator 212. The input “N” may be connected to the power supply circuit 272 (see FIG. 3) and the supply voltage measurement circuit 274 (see FIG. 3). The power source 232 may also be connected and provide power to the blower fan switch 204, the blower assembly 216, the A/C switch 206, the thermostat switch 207, and the compressor clutch 218. The blower assembly 216, the A/C switch 206, and the thermostat switch 207 may each be connected to the ground 236.

The input “P” (labeled “CONTROL SIGNAL” in FIG. 2) is connected (e.g., by a conductor 238, a wireless connection, and the like) to the input 208. The input 208 sends a control signal encoding a temperature setpoint value (e.g., as a voltage value) to the input “P.” The temperature setpoint value is within a range from a minimum setpoint temperature value to a maximum setpoint temperature value. By way of non-limiting examples, the minimum setpoint temperature value may be encoded in the control signal as a minimum voltage value (e.g., 0V) and the maximum setpoint temperature value may be encoded in the control signal as a maximum voltage value (e.g., Vbat). Referring to FIG. 3, the input “P” may be connected to the control signal conditioning circuit 282. The control signal conditioning circuit 282 may be connected to the processor 264 and/or the memory 266 and configured to provide the control signal and/or the temperature setpoint value thereto.

Referring to FIG. 2, by way of a non-limiting example, the input 208 may be implemented as a user input (e.g., mounted on a panel inside the passenger compartment 205). In such embodiments, the input 208 is configured to be manually adjusted by a human operator. The input 208 may include and display a plurality of temperature settings each corresponding to a different setpoint temperature value within the range. Thus, the input 208 may be manually adjustable to a displayed value corresponding to the desired temperature setpoint value. The input 208 may include a potentiometer 244 that allows the operator to select any desired setpoint temperature value within the range. Alternatively, the input 208 may be configured to receive a command from another device (not shown) and encode the temperature setpoint value in the control signal based at least in part on that command.

The input “R” (labeled “CAB TEMP” in FIG. 2) is connected (e.g., by a conductor 246, a wireless connection, and the like) to the first sensor 222. The first sensor 222 sends a first sensor signal to the input “R.” The first sensor 222 is positioned to sense an air temperature inside the passenger compartment 205. The first sensor signal encodes a first measured temperature value of the air inside the passenger compartment 205. Thus, the first sensor signal may provide feedback to the actuator 212 in a first temperature control loop. Referring to FIG. 3, the input “R” may be connected to the temperature sensor input circuit 280. The temperature sensor input circuit 280 may be connected to the processor 264 and/or the memory 266 and configured to provide the first sensor signal and/or the first measured temperature value thereto. As discussed below, referring to FIG. 2, the first measured temperature value is used by the actuator 212 to control heat output by the heat-supplying device 220.

The input “S” (labeled “DUCT TEMP” in FIG. 2) is connected (e.g., by a conductor 248, a wireless connection, and the like) to the second sensor 224. The second sensor 224 sends a second sensor signal to the input “S.” The second sensor 224 is positioned (e.g., in the duct(s) 228) to measure the temperature of discharged air. The second sensor 224 encodes a second measured temperature value of discharged air into the second sensor signal. Thus, the second sensor signal may provide feedback to the actuator 212. Referring to FIG. 3, the input “S” may be connected to the temperature sensor input circuit 280. The temperature sensor input circuit 280 may be connected to the processor 264 and/or the memory 266 and configured to provide the second sensor signal and/or the second measured temperature value thereto. As discussed below, referring to FIG. 2, the second measured temperature value may be used by the actuator 212 to control heat output by the heat-supplying device 220. The second measured temperature value may also be used by the actuator 212 to improve occupant comfort by reducing fluctuations in the temperature of the discharged air, which are known to cause discomfort.

The output “O” (labeled “LIN” in FIG. 2) is connected to a serial data bus 250. The output “O” may also be connected to the LIN transceiver circuit 278 (see FIG. 3), which is configured to communicate over the serial data bus 250. The serial data bus 250 may be used to provide diagnostic information if desired.

The actuator 212 is connected to the heat-supplying device 220 by the shaft 260. The actuator 212 converts electrical power received from the power source 232 into rotary action by the shaft 260. The rotation component(s) 262 is/are configured to rotate the shaft 260 in response to commands from the processor 264. Referring to FIG. 3, the rotation component(s) 262 may be connected to the processor 264 by the H-bridge driver circuit 276. Thus, the H-bridge driver circuit 276 may be a link between the processor 264 and the rotation component(s) 262. Referring to FIG. 2, the actuator 212 may be implemented as a multi-position actuator in which the rotation component(s) 262 is/are configured to rotate the shaft 260 clockwise and/or counterclockwise between a predetermined number of angular positions. Alternatively, the actuator 212 may not be limited to the predetermined number of angular positions. Instead, the rotation component(s) 262 may be configured to provide continuous clockwise and/or counterclockwise rotation of the shaft 260.

The shaft 260 controls the heat that is injected into the passenger compartment 205 by the heat-supplying device 220. For example, the heat-supplying device 220 may be implemented as a heater water valve. In such embodiments, the shaft 260 opens or closes the heater water valve to control thereby an amount of heated air entering the duct(s) 228. Alternatively, the heat-supplying device 220 may be implemented as a blend door that controls or blends an amount of heated air and an amount of cooled air (e.g., supplied by the air conditioning subsystem) before the blend enters the passenger compartment 205 through the outlet(s) 226 of the duct(s) 228.

The processor 264 (e.g., a microcontroller) is connected to the memory 266. The memory 266 stores embedded software instructions 270 that are executable by the processor 264. The actuator 212 is implemented by one or more electronic components that is/are small enough to fit inside commercially available space. The instructions 270 may be configured to be stored on the memory 266, which is small enough to fit inside the commercially available space.

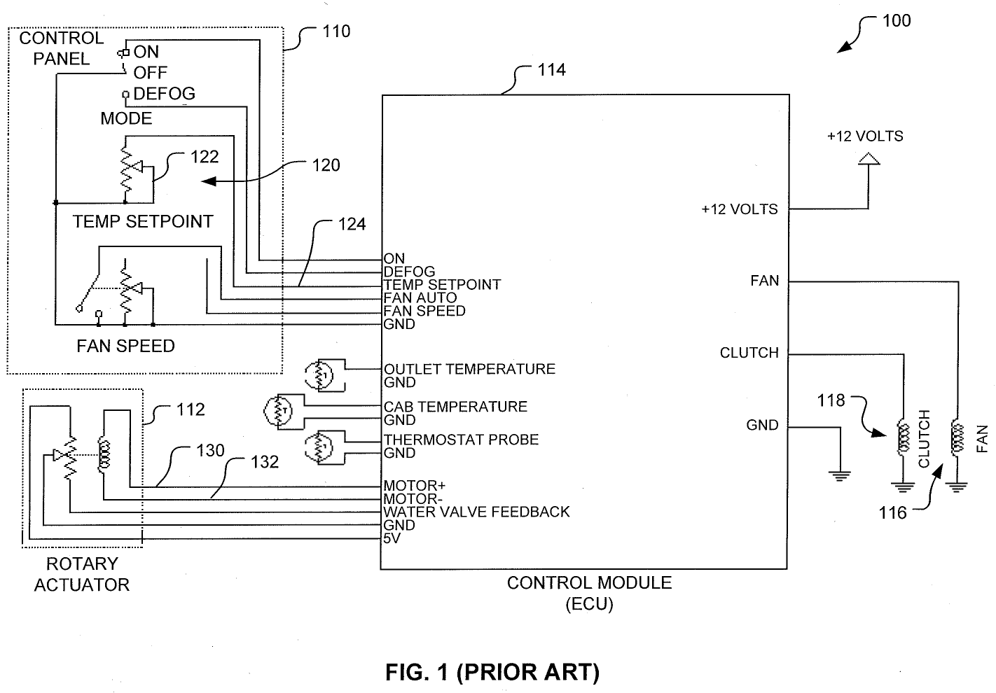

Unlike the prior art rotary actuator 112 (see FIG. 1), the actuator 212 does not directly produce a rotational angle command based solely on the temperature setpoint received from the input 208. Instead, the instructions 270 cause the processor 264 to calculate a rotational angle command value based at least in part on a comparison of the temperature setpoint value (received from the input 208) to the first measured temperature value (received from the first sensor 222) and/or the second measured temperature value (received from the second sensor 224).

For example, the instructions 270 may cause the processor 264 to implement first and second temperature control loops. The first and second temperature control loops run simultaneously and may each be implemented as a proportional-integral-derivative (“PID”) control loop. The first temperature control loop receives, as inputs, the desired temperature setpoint value and the first measured temperature value and outputs a first temperature difference between the desired temperature setpoint value and the first measured temperature value. The instructions 270 may cause the processor 264 to determine a desired discharge temperature setpoint value based at least in part on the first temperature difference. The second temperature control loop receives, as inputs, the desired discharge temperature setpoint value and the second measured temperature value (from the second sensor 224) and outputs a second temperature difference between the desired discharge temperature setpoint value and the second measured temperature value.

The first temperature control loop has a relatively long time constant between receiving a new temperature setpoint value (encoded in the control signal) and the first measured temperature value corresponding to (e.g., being equal to a temperature encoded in) that new temperature setpoint value. The second temperature control loop has a relatively short time constant between receiving the desired discharge temperature setpoint value (from the first temperature control loop) and the second measured temperature value corresponding to (e.g., being equal to a temperature encoded in) the desired discharge temperature setpoint value. Thus, by using both the first and second temperature control loops to control the amount of heat entering the passenger compartment 205, the circuit 200 may respond quicker and/or more accurately to changes in the temperature setpoint value. Additionally, the circuit 200 may reduce fluctuations in the temperature of the discharged air.

Then, the instructions 270 may cause the processor 264 to calculate the rotational angle command value based at least in part on the first temperature difference and/or the second temperature difference. For example, when the first temperature difference is zero, the instructions 270 may cause the processor 264 to calculate a rotational angle command value that causes the heat-supplying device 220 to continue adding the same amount of heat to the passenger compartment 205. On the other hand, when the first temperature difference is other than zero, the instructions 270 may cause the processor 264 to calculate a new rotational angle command value that causes the heat-supplying device 220 to contribute more or less heat to the passenger compartment 205 based at least in part on the magnitude of the first and/or second temperature differences. The amount of heat contributed may be determined based on a predefined heating curve, a lookup table, and the like. For example, the first temperature difference may be used to lookup a corresponding desired discharge temperature setpoint value on the predefined heating curve, in the lookup table, and the like. Then, the second temperature difference may be calculated and used to determine the new rotational angle command value (e.g., using a lookup table, and the like).

Next, the instructions 270 cause the processor 264 to provide the rotational angle command value to the rotation component(s) 262. The rotation component(s) 262 rotate the shaft 260 in accordance with the rotational angle command value. The rotation of the shaft 260 increases or decreases heat contributed by the heat-supplying device 220 to change thereby the air temperature inside the passenger compartment 205. Thus, the processor 264 changes the rotary position of the shaft 260 to adjust the air temperature inside the passenger compartment 205 (e.g., to match a temperature indicated by the temperature setpoint value).

Optionally, the instructions 270 may cause the processor 264 to output diagnostic information onto the serial data bus 250 via the output “O.” By way of a non-limiting example, the serial data bus 250 may be connected to a recipient device (not shown) configured to receive the diagnostic information from the actuator 212.

The actuator 212 may be used instead of or in place of the rotary actuator 112 (see FIG. 1). In such embodiments, the ECU 114 (see FIG. 1) may be omitted. The actuator 212 may cost little more than the prior art rotary actuator 112 (see FIG. 1). Thus, the circuit 200 may provide cost savings when compared with the prior art circuit 100 (see FIG. 1).

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood with the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B, and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context.

Accordingly, the invention is not limited except as by the appended claims.

The invention claimed is:

1. An Automatic Temperature Control (“ATC”) system for use with a control signal encoding a desired temperature setpoint value, the ATC system comprising:
a heat-supplying device;
a sensor configured to detect air temperature and send a sensor signal encoding a measured temperature value; and
a rotary actuator comprising a rotatable shaft connected to the heat-supplying device, at least one processor, and memory storing instructions executable by the at least one processor, the rotary actuator being operable to receive both the control signal and the sensor signal, the instructions, when executed by the at least one processor, causing the at least one processor to determine a temperature difference between the desired temperature setpoint value and the measured temperature value, and rotate the rotatable shaft based at least in part on the temperature difference, the rotation of the rotatable shaft increasing or decreasing heat contributed by the heat-supplying device to thereby change the air temperature.

2. The ATC system of claim 1, further comprising:
a user input configured to send the control signal to the rotary actuator, the user input being manually adjustable by a human operator to a displayed value corresponding to the desired temperature setpoint value.

3. The ATC system of claim 1, wherein the sensor is a first sensor, the sensor signal is a first sensor signal, the measured temperature value is a first measured temperature value, and the ATC system further comprises:
a second sensor positioned inside a selected heating duct that receives the heat output by the heat-supplying device, the second sensor being configured to detect a discharged air temperature and send a second sensor signal encoding a second measured temperature value to the rotary actuator, the rotary actuator being configured to use the second measured temperature value to reduce fluctuations in the discharged air temperature.

4. The ATC system of claim 3, wherein the instructions, when executed by the at least one processor, implement a first temperature control loop configured to output a first temperature difference between the desired temperature setpoint value and the first measured temperature value,
the instructions, when executed by the at least one processor, cause the at least one processor to determine a desired discharge temperature setpoint value based at least in part on the first temperature difference,
the instructions, when executed by the at least one processor, cause the at least one processor to determine a second temperature difference between the desired discharge temperature setpoint value and the second measured temperature value,
the instructions, when executed by the at least one processor, cause the at least one processor to determine a rotational angle command value based at least in part on one or both of the first and second temperature differences,
the rotary actuator comprises one of more rotation components configured to rotate the rotatable shaft in accordance with the rotational angle command value, and
the instructions, when executed by the at least one processor, cause the at least one processor to provide the rotational angle command value to the one of more rotation components, which rotate the rotatable shaft in accordance therewith.

5. The ATC system of claim 1, wherein the sensor is configured to detect the air temperature inside a passenger compartment of a vehicle.

6. The ATC system of claim 5, wherein the heat-supplying device is a blend door configured to blend an amount of heated air and an amount of cooled air before the blended heated and cooled air enters the passenger compartment.

7. The ATC system of claim 1, wherein the heat-supplying device is a heater water valve.

8. The ATC system of claim 1, wherein the rotary actuator is a multi-position actuator configured to rotate the rotatable shaft between a predetermined number of angular positions.

9. A rotary actuator for use with a heat-supplying device, a desired temperature setpoint value, and a measured temperature value, the rotary actuator comprising:
a rotatable shaft connectable to the heat-supplying device;
at least one processor; and
memory storing instructions executable by the at least one processor, the instructions, when executed by the at least one processor, causing the at least one processor to determine a temperature difference between the desired temperature setpoint value and the measured temperature value, and rotate the rotatable shaft based at least in part on the temperature difference, the rotation of the rotatable shaft increasing or decreasing heat contributed by the heat-supplying device when the rotatable shaft is connected to the heat-supplying device.

10. The rotary actuator of claim 9, further comprising:
one of more rotation components configured to rotate the rotatable shaft in accordance with a rotational angle command value, the instructions, when executed by the at least one processor, causing the at least one processor to determine the rotational angle command value based at least in part on the temperature difference and provide the rotational angle command value to the one of more rotation components.

11. The rotary actuator of claim 10, wherein the one of more rotation components are configured to rotate the rotatable shaft between a predetermined number of angular positions.

12. The rotary actuator of claim 10, further comprising:
an outer housing, the one of more rotation components being positioned inside the outer housing, the rotatable shaft having a proximal end connected to the one of more rotation components inside the outer housing, the rotatable shaft having a distal end extending outwardly from the outer housing, the distal end being connectable to the heat-supplying device, the at least one processor and the memory being positioned inside the outer housing.

13. The rotary actuator of claim 9, further comprising:
a first input configured to receive the desired temperature setpoint value; and
a second input configured to receive the measured temperature value from a sensor.

14. The rotary actuator of claim 13, wherein the first input is configured to receive the desired temperature setpoint value from a user input.

15. The rotary actuator of claim 9 for use with a second measured temperature value, the measured temperature value being a first measured temperature value, the rotary actuator further comprising one of more rotation components configured to rotate the rotatable shaft in accordance with a rotational angle command value, wherein the instructions, when executed by the at least one processor, implement a first temperature control loop configured to output a first temperature difference between the desired temperature setpoint value and the first measured temperature value,
the instructions, when executed by the at least one processor, cause the at least one processor to determine a desired discharge temperature setpoint value based at least in part on the first temperature difference,
the instructions, when executed by the at least one processor, cause the at least one processor to determine a second temperature difference between the desired discharge temperature setpoint value and the second measured temperature value,
the instructions, when executed by the at least one processor, cause the at least one processor to determine the rotational angle command value based at least in part on one or both of the first and second temperature differences, and
the instructions, when executed by the at least one processor, cause the at least one processor to provide the rotational angle command value to the one of more rotation components, which rotate the rotatable shaft in accordance therewith.

16. A method comprising:
receiving, by a rotary actuator, a desired temperature setpoint value;
receiving, by the rotary actuator, a first measured temperature value from a first temperature sensor, the first measured temperature value being an air temperature measurement from inside a passenger compartment of a vehicle;
calculating, by the rotary actuator, a first temperature difference between the desired temperature setpoint value and the first measured temperature value;
determining, by the rotary actuator, a desired discharge temperature setpoint value based at least in part on the first temperature difference;
receiving, by the rotary actuator, a second measured temperature value from a second temperature sensor, the second measured temperature value being a discharged air temperature measurement collected from a duct receiving heated air from a heat-supplying device;
calculating, by the rotary actuator, a second temperature difference between the desired discharge temperature setpoint value and the second measured temperature value;
determining, by the rotary actuator, an amount of rotation based at least in part on one or both of the first and second temperature differences; and
rotating, by the rotary actuator, a rotatable shaft by the amount of rotation, the rotation of the rotatable shaft increasing or decreasing heat contributed by the heat-supplying device connected to the rotatable shaft.

17. The method of claim 16, wherein the desired temperature setpoint value is received from a user input that is manually adjustable by a human operator to a displayed value corresponding to the desired temperature setpoint value.

18. The method of claim 16, wherein the heat-supplying device is a heater water valve.

19. The method of claim 16, wherein the rotary actuator is a multi-position actuator configured to rotate the rotatable shaft between a predetermined number of angular positions.
